(19) United States
(12) Patent Application Publication
(10) Pub. No.: US 2024/0040617 A1
(43) Pub. Date: Feb. 1, 2024

(54) TECHNIQUES FOR USER EQUIPMENT INITIATED CHANNEL OCCUPANCY TIME CONFIGURATION AND INDICATION

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US); Hao XU, Beijing (CN); Rajat PRAKASH, San Diego, CA (US); Luanxia YANG, Beijing (CN); Siyi CHEN, Beijing (CN)

(21) Appl. No.: 18/252,708

(22) PCT Filed: Jan. 28, 2021
(86) PCT No.: PCT/CN2021/074086

§ 371 Date: May 11, 2023

(51) Int. Cl. H04W 74/08; H04W 74/00

(52) U.S. Cl. CPC H04W 74/0808; H04W 74/006

(57) ABSTRACT

Various aspects of the present disclosure generally relate to wireless communication. In some aspects, a user equipment (UE) may receive, from a base station, a channel occupancy time (COT) duration indication that indicates a first COT duration associated with a first channel occupancy initiated by the base station. The UE may initiate, during a time duration that is outside of the first COT duration and based at least in part on performing a listen-before-talk procedure, a second channel occupancy having a second COT duration. Numerous other aspects are described.

### FIELD OF THE DISCLOSURE

Aspects of the present disclosure generally relate to wireless communication and to techniques and apparatuses for user equipment initiated channel occupancy time configuration and indication.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station, a channel occupancy time (COT) duration indication that indicates a first COT duration associated with a first channel occupancy initiated by the base station; and initiating, during a time duration that is outside of the first COT duration and based at least in part on performing a listen-before-talk (LBT) procedure, a second channel occupancy having a second COT duration.

In some aspects, receiving the COT duration indication comprises receiving downlink control information (DCI) that includes the first COT duration indication.

In some aspects, the DCI comprises a DCI format 2_0 transmission.

In some aspects, the first COT duration is associated with a COT of a base station fixed frame period (FFP), the second COT duration is associated with a COT of a UE FFP, and the COT of the UE FFP is outside of the COT of the base station FFP.

In some aspects, the method includes refraining from performing the LBT procedure during the first COT duration.

In some aspects, the method includes refraining from performing the LBT procedure during an idle period of a base station FFP.

In some aspects, the method includes receiving a COT configuration that indicates at least one parameter, wherein the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, a method of wireless communication performed by a base station includes initiating, based at least in part on an LBT procedure, a first channel occupancy having a first COT duration; and transmitting, to a UE, a first COT duration indication that indicates a first COT duration associated with the first channel occupancy, wherein a second channel occupancy initiated by the UE has a second COT duration.

In some aspects, transmitting the first COT duration indication comprises transmitting DCI that includes the first COT duration indication.

In some aspects, the DCI comprises a DCI format 2_0 transmission.

In some aspects, the first COT duration corresponds to a first portion of a base station FFP, the second COT duration is associated with a COT of a UE FFP, and the COT of the UE FFP is outside of the COT of the base station FFP.

In some aspects, the method includes transmitting a COT configuration that indicates at least one parameter, wherein the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, a method of wireless communication performed by a UE includes initiating, based at least in part on performing an LBT procedure, a first channel occupancy having a first COT duration, wherein the first COT duration corresponds to a first portion of a UE FFP; and communicating with a base station based at least in part on a second COT duration associated with a second channel occupancy initiated by the base station, wherein the second COT duration is associated with a COT of a base station FFP, and wherein the COT of the base station FFP is outside of the COT of a UE FFP.

In some aspects, the method includes receiving, from the base station, a COT duration indication that indicates the first COT duration.

In some aspects, receiving the COT duration indication comprises receiving a radio resource control message including a configuration that includes the first COT duration indication.

In some aspects, receiving the COT duration indication comprises receiving a DCI transmission that includes the COT duration indication.

In some aspects, the DCI comprises an uplink resource grant.

In some aspects, the method includes transmitting, to the base station, a COT duration indication that indicates the first COT duration.

In some aspects, transmitting the COT duration indication comprises transmitting a configured grant (CG)-uplink control information (CG-UCI) transmission that includes the COT duration indication.

In some aspects, the COT duration indication comprises: a COT sharing information field of the CG-UCI transmission, or a dedicated COT duration indication field of the CG-UCI transmission.

In some aspects, the second COT duration terminates at a boundary of a base station FFP.

In some aspects, a method of wireless communication performed by a base station includes communicating with a UE based at least in part on a first COT duration associated with a first channel occupancy initiated by the UE, wherein the first COT duration corresponds to a first portion of a UE FFP; and initiating, based at least in part on performing an LBT procedure, a second channel occupancy having a second COT duration, wherein the second COT duration is associated with a COT of a base station FFP, wherein the COT of the base station FFP is outside of the COT of a UE FFP.

In some aspects, the method includes transmitting, to the UE, a COT duration indication that indicates the first COT duration.

In some aspects, transmitting the COT duration indication comprises transmitting a radio resource control message including a configuration that includes the first COT duration indication.

In some aspects, transmitting the COT duration indication comprises transmitting a DCI transmission that includes the COT duration indication.

In some aspects, the DCI comprises an uplink resource grant.

In some aspects, the method includes receiving, from the UE, a COT duration indication that indicates the first COT duration.

In some aspects, receiving the COT duration indication comprises receiving a CG-UCI transmission that includes the COT duration indication.

In some aspects, the COT duration indication comprises: a COT sharing information field of the CG-UCI transmission, or a dedicated COT duration indication field of the CG-UCI transmission.

In some aspects, the method includes terminating the second COT duration at a boundary of a base station FFP.

In some aspects, a UE for wireless communication includes a memory; and one or more processors coupled to the memory, the memory and the one or more processors configured to: receive, from a base station, a COT duration indication that indicates a first COT duration associated with a first channel occupancy initiated by the base station; and initiate, during a time duration that is outside of the first COT duration and based at least in part on performing an LBT procedure, a second channel occupancy having a second COT duration.

In some aspects, the memory and the one or more processors, when receiving the COT duration indication, are configured to receive DCI that includes the first COT duration indication.

In some aspects, the DCI comprises a DCI format 2_0 transmission.

In some aspects, the first COT duration is associated with a COT of a base station FFP, the second COT duration is associated with a COT of a UE FFP, and the COT of the UE FFP is outside of the COT of the base station FFP.

In some aspects, the memory and the one or more processors are further configured to refrain from performing the LBT procedure during the first COT duration.

In some aspects, the memory and the one or more processors are further configured to refrain from performing the LBT procedure during an idle period of a base station FFP.

In some aspects, the memory and the one or more processors are further configured to receive a COT configuration that indicates at least one parameter, the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, a base station for wireless communication includes a memory; and one or more processors coupled to the memory, the memory and the one or more processors configured to: initiate, based at least in part on an LBT procedure, a first channel occupancy having a first COT duration; and transmit, to a UE, a first COT duration indication that indicates a first COT duration associated with the first channel occupancy, wherein a second channel occupancy initiated by the UE has a second COT duration.

In some aspects, the memory and the one or more processors, when transmitting the first COT duration indication, are configured to DCI that includes the first COT duration indication.

In some aspects, the DCI comprises a DCI format 2_0 transmission.

In some aspects, the first COT duration corresponds to a first portion of a base station FFP, the second COT duration is associated with a COT of a UE FFP, and the COT of the UE FFP is outside of the COT of the base station FFP.

In some aspects, the memory and the one or more processors are further configured to transmit a COT configuration that indicates at least one parameter, the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, a UE for wireless communication includes a memory; and one or more processors operatively coupled to the memory, the memory and the one or more processors configured to: initiate, based at least in part on performing an LBT procedure, a first channel occupancy having a first COT duration, wherein the first COT duration corresponds to a first portion of a UE FFP; and communicate with a base station based at least in part on a second COT duration associated with a second channel occupancy initiated by the base station, wherein the second COT duration is associated with a COT of a base station FFP, and wherein the COT of the base station FFP is outside of the COT of a UE FFP.

In some aspects, the memory and the one or more processors are further configured to receive, from the base station, a COT duration indication that indicates the first COT duration.

In some aspects, the memory and the one or more processors, when receiving the COT duration indication, are configured to receive a radio resource control message including a configuration that includes the first COT duration indication.

In some aspects, the memory and the one or more processors, when receiving the COT duration indication, are configured to receive a DCI transmission that includes the COT duration indication.

In some aspects, the DCI comprises an uplink resource grant.

In some aspects, the memory and the one or more processors are further configured to transmit, to the base station, a COT duration indication that indicates the first COT duration.

In some aspects, the memory and the one or more processors, when transmitting the COT duration indication, are configured to transmit a CG-UCI transmission that includes the COT duration indication.

In some aspects, the COT duration indication comprises: a COT sharing information field of the CG-UCI transmission, or a dedicated COT duration indication field of the CG-UCI transmission.

In some aspects, the second COT duration terminates at a boundary of a base station FFP.

In some aspects, a base station for wireless communication includes a memory; and one or more processors operatively coupled to the memory, the memory and the one or more processors configured to: communicate with a UE based at least in part on a first COT duration associated with a first channel occupancy initiated by the UE, wherein the first COT duration corresponds to a first portion of a UE FFP; and initiate, based at least in part on performing an LBT procedure, a second channel occupancy having a second COT duration, wherein the second COT duration is associated with a COT of a base station FFP, wherein the COT of the base station FFP is outside of the COT of a UE FFP.

In some aspects, the memory and the one or more processors are further configured to transmit, to the UE, a COT duration indication that indicates the first COT duration.

In some aspects, the memory and the one or more processors, when transmitting the COT duration indication, are configured to transmit a radio resource control message including a configuration that includes the first COT duration indication.

In some aspects, the memory and the one or more processors, when transmitting the COT duration indication, are configured to transmit a DCI transmission that includes the COT duration indication.

In some aspects, the DCI comprises an uplink resource grant.

In some aspects, the memory and the one or more processors are further configured to receive, from the UE, a COT duration indication that indicates the first COT duration.

In some aspects, the memory and the one or more processors, when receiving the COT duration indication, are configured to receive a CG-UCI transmission that includes the COT duration indication.

In some aspects, the COT duration indication comprises: a COT sharing information field of the CG-UCI transmission, or a dedicated COT duration indication field of the CG-UCI transmission.

In some aspects, the memory and the one or more processors are further configured to terminate the second COT duration at a boundary of a base station FFP.

In some aspects, a non-transitory computer-readable medium storing a set of instructions for wireless communication includes one or more instructions that, when executed by one or more processors of a UE, cause the UE to: receive, from a base station, a COT duration indication that indicates a first COT duration associated with a first channel occupancy initiated by the base station; and initiate, during a time duration that is outside of the first COT duration and based at least in part on performing an LBT procedure, a second channel occupancy having a second COT duration.

In some aspects, the one or more instructions, that cause the UE to receive the COT duration indication, cause the UE to receive DCI that includes the first COT duration indication.

In some aspects, the DCI comprises a DCI format 2_0 transmission.

In some aspects, the first COT duration is associated with a COT of a base station FFP, the second COT duration is associated with a COT of a UE FFP, and the COT of the UE FFP is outside of the COT of the base station FFP.

In some aspects, the one or more instructions further cause the UE to refrain from performing the LBT procedure during the first COT duration.

In some aspects, the one or more instructions further cause the UE to refrain from performing the LBT procedure during an idle period of a base station FFP.

In some aspects, the one or more instructions further cause the UE to receive a COT configuration that indicates at least one parameter, the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, a non-transitory computer-readable medium storing a set of instructions for wireless communication includes one or more instructions that, when executed by one or more processors of a base station, cause the base station to: initiate, based at least in part on an LBT procedure, a first channel occupancy having a first COT duration; and transmit, to a UE, a first COT duration indication that indicates a first COT duration associated with the first channel occupancy, wherein a second channel occupancy initiated by the UE has a second COT duration.

In some aspects, the one or more instructions, that cause the base station to transmit the first COT duration indication, cause the base station to transmit DCI that includes the first COT duration indication.

In some aspects, the DCI comprises a DCI format 2_0 transmission.

In some aspects, the first COT duration corresponds to a first portion of a base station FFP, the second COT duration is associated with a COT of a UE FFP, and the COT of the UE FFP is outside of the COT of the base station FFP.

In some aspects, the one or more instructions further cause the base station to transmit a COT configuration that indicates at least one parameter, the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, a non-transitory computer-readable medium storing a set of instructions for wireless communication includes one or more instructions that, when executed by one or more processors of an UE, cause the UE to: initiate, based at least in part on performing an LBT procedure, a first channel occupancy having a first COT duration, wherein the first COT duration corresponds to a first portion of a UE FFP; and communicate with a base station based at least in part on a second COT duration associated with a second channel occupancy initiated by the base station, wherein the second COT duration is associated with a COT of a base station FFP, and wherein the COT of the base station FFP is outside of the COT of a UE FFP.

In some aspects, the one or more instructions further cause the UE to receive, from the base station, a COT duration indication that indicates the first COT duration.

In some aspects, the one or more instructions, that cause the UE to receive the COT duration indication, cause the UE to receive a radio resource control message including a configuration that includes the first COT duration indication.

In some aspects, the one or more instructions, that cause the UE to receive the COT duration indication, cause the UE to receive a DCI transmission that includes the COT duration indication.

In some aspects, the DCI comprises an uplink resource grant.

In some aspects, the one or more instructions further cause the UE to transmit, to the base station, a COT duration indication that indicates the first COT duration.

In some aspects, the one or more instructions, that cause the UE to transmit the COT duration indication, cause the UE to transmit a CG-UCI transmission that includes the COT duration indication.

In some aspects, the COT duration indication comprises: a COT sharing information field of the CG-UCI transmission, or a dedicated COT duration indication field of the CG-UCI transmission.

In some aspects, the second COT duration terminates at a boundary of a base station FFP.

In some aspects, a non-transitory computer-readable medium storing a set of instructions for wireless communication includes one or more instructions that, when executed by one or more processors of a base station, cause the base station to: communicate with a UE based at least in part on a first COT duration associated with a first channel occupancy initiated by the UE, wherein the first COT duration corresponds to a first portion of a UE FFP; and initiate, based at least in part on performing an LBT procedure, a second channel occupancy having a second COT duration, wherein the second COT duration is associated with a COT of a base station FFP, wherein the COT of the base station FFP is outside of the COT of a UE FFP.

In some aspects, the one or more instructions further cause the base station to transmit, to the UE, a COT duration indication that indicates the first COT duration.

In some aspects, the one or more instructions, that cause the base station to transmit the COT duration indication, cause the base station to transmit a radio resource control message including a configuration that includes the first COT duration indication.

In some aspects, the one or more instructions, that cause the base station to transmit the COT duration indication, cause the base station to transmit a DCI transmission that includes the COT duration indication.

In some aspects, the DCI comprises an uplink resource grant.

In some aspects, the one or more instructions further cause the base station to receive, from the UE, a COT duration indication that indicates the first COT duration.

In some aspects, the one or more instructions, that cause the base station to receive the COT duration indication, cause the base station to receive a CG-UCI transmission that includes the COT duration indication.

In some aspects, the COT duration indication comprises: a COT sharing information field of the CG-UCI transmission, or a dedicated COT duration indication field of the CG-UCI transmission.

In some aspects, the one or more instructions further cause the base station to terminate the second COT duration at a boundary of a base station FFP.

In some aspects, an apparatus for wireless communication includes means for receiving, from a base station, a COT duration indication that indicates a first COT duration associated with a first channel occupancy initiated by the base station; and means for initiating, during a time duration that is outside of the first COT duration and based at least in part on performing an LBT procedure, a second channel occupancy having a second COT duration.

In some aspects, the means for receiving the COT duration indication comprises means for receiving DCI that includes the first COT duration indication.

In some aspects, the DCI comprises a DCI format 2_0 transmission.

In some aspects, the first COT duration is associated with a COT of a base station FFP, the second COT duration is associated with a COT of a UE FFP, and the COT of the UE FFP is outside of the COT of the base station FFP.

In some aspects, the apparatus includes means for refraining from performing the LBT procedure during the first COT duration.

In some aspects, the apparatus includes means for refraining from performing the LBT procedure during an idle period of a base station FFP.

In some aspects, the apparatus includes means for receiving a COT configuration that indicates at least one parameter, wherein the at least one parameter comprises at least one of: an indication that the apparatus is allowed to initiate the second channel occupancy during a base station FFP based at least in part on the base station initiating the first channel occupancy during the base station FFP, an indication that the apparatus is not allowed to initiate the second channel occupancy during a base station FFP based at least in part on the base station initiating the first channel occupancy during the base station FFP, or an indication that the apparatus is allowed to initiate the second channel occupancy during a base station FFP based at least in part on the first COT duration, wherein the first channel occupancy was initiated during the base station FFP.

In some aspects, an apparatus for wireless communication includes means for initiating, based at least in part on an LBT procedure, a first channel occupancy having a first COT duration; and means for transmitting, to a UE, a first COT duration indication that indicates a first COT duration associated with the first channel occupancy, wherein a second channel occupancy initiated by the UE has a second COT duration.

In some aspects, the means for transmitting the first COT duration indication comprises means for transmitting DCI that includes the first COT duration indication.

In some aspects, the DCI comprises a DCI format 2_0 transmission.

In some aspects, the first COT duration corresponds to a first portion of a base station FFP, the second COT duration is associated with a COT of a UE FFP, and the COT of the UE FFP is outside of the COT of the base station FFP.

In some aspects, the apparatus includes means for transmitting a COT configuration that indicates at least one parameter, wherein the at least one parameter comprises at least one of: an indication that the UE is allowed to initiate the second channel occupancy during a base station FFP based at least in part on the apparatus initiating the first channel occupancy during the base station FFP, an indication that the UE is not allowed to initiate the second channel occupancy during a base station FFP based at least in part on the apparatus initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, an apparatus for wireless communication includes means for initiating, based at least in part on performing an LBT procedure, a first channel occupancy having a first COT duration, wherein the first COT duration corresponds to a first portion of a UE FFP; and means for communicating with a base station based at least in part on a second COT duration associated with a second channel occupancy initiated by the base station, wherein the second COT duration is associated with a COT of a base station FFP, and wherein the COT of the base station FFP is outside of the COT of a UE FFP.

In some aspects, the apparatus includes means for receiving, from the base station, a COT duration indication that indicates the first COT duration.

In some aspects, the means for receiving the COT duration indication comprises means for receiving a radio resource control message including a configuration that includes the first COT duration indication.

In some aspects, the means for receiving the COT duration indication comprises means for receiving a DCI transmission that includes the COT duration indication.

In some aspects, the DCI comprises an uplink resource grant.

In some aspects, the apparatus includes means for transmitting, to the base station, a COT duration indication that indicates the first COT duration.

In some aspects, the means for transmitting the COT duration indication comprises means for transmitting a CG-UCI transmission that includes the COT duration indication.

In some aspects, the COT duration indication comprises: a COT sharing information field of the CG-UCI transmission, or a dedicated COT duration indication field of the CG-UCI transmission.

In some aspects, the second COT duration terminates at a boundary of a base station FFP.

In some aspects, an apparatus for wireless communication includes means for communicating with a UE based at least in part on a first COT duration associated with a first channel occupancy initiated by the UE, wherein the first COT duration corresponds to a first portion of a UE FFP; and means for initiating, based at least in part on performing an LBT procedure, a second channel occupancy having a second COT duration, wherein the second COT duration is associated with a COT of a base station FFP, wherein the COT of the base station FFP is outside of the COT of a UE FFP.

In some aspects, the apparatus includes means for transmitting, to the UE, a COT duration indication that indicates the first COT duration.

In some aspects, the means for transmitting the COT duration indication comprises means for transmitting a radio resource control message including a configuration that includes the first COT duration indication.

In some aspects, the means for transmitting the COT duration indication comprises means for transmitting a DCI transmission that includes the COT duration indication.

In some aspects, the DCI comprises an uplink resource grant.

In some aspects, the apparatus includes means for receiving, from the UE, a COT duration indication that indicates the first COT duration.

In some aspects, the means for receiving the COT duration indication comprises means for receiving a CG-UCI transmission that includes the COT duration indication.

In some aspects, the COT duration indication comprises: a COT sharing information field of the CG-UCI transmission, or a dedicated COT duration indication field of the CG-UCI transmission.

In some aspects, the apparatus includes means for terminating the second COT duration at a boundary of a base station FFP.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIGS. 3-7 are diagrams illustrating examples associated with user equipment (UE) initiated channel occupancy time (COT) configuration and indication, in accordance with the present disclosure.

FIGS. 8-11 are diagrams illustrating example processes associated with UE initiated COT configuration and indication, in accordance with the present disclosure.

FIGS. 12 and 13 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

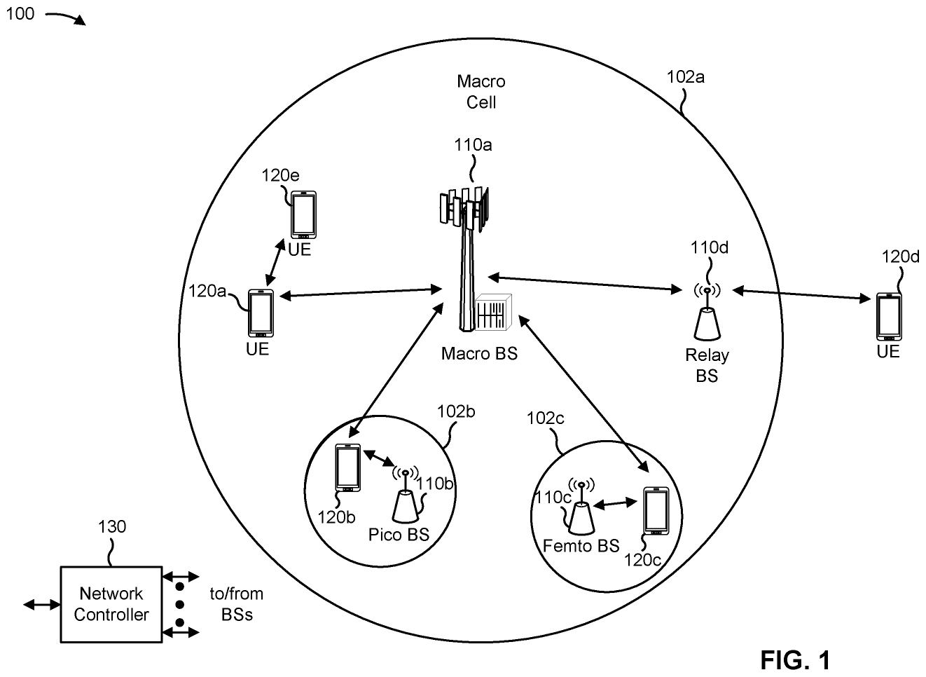

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

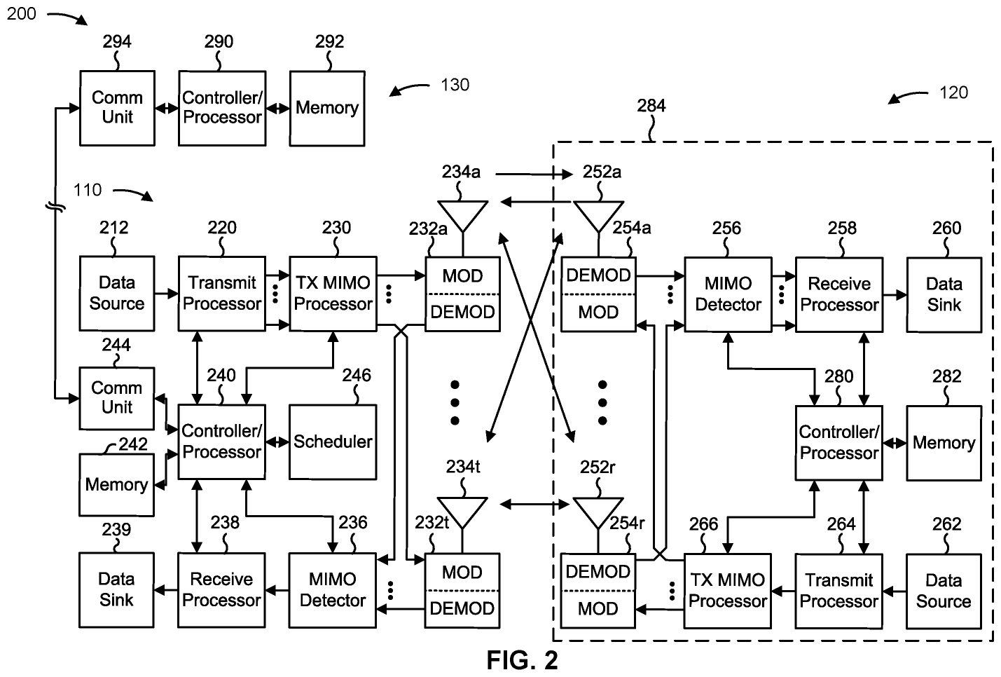

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, an/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

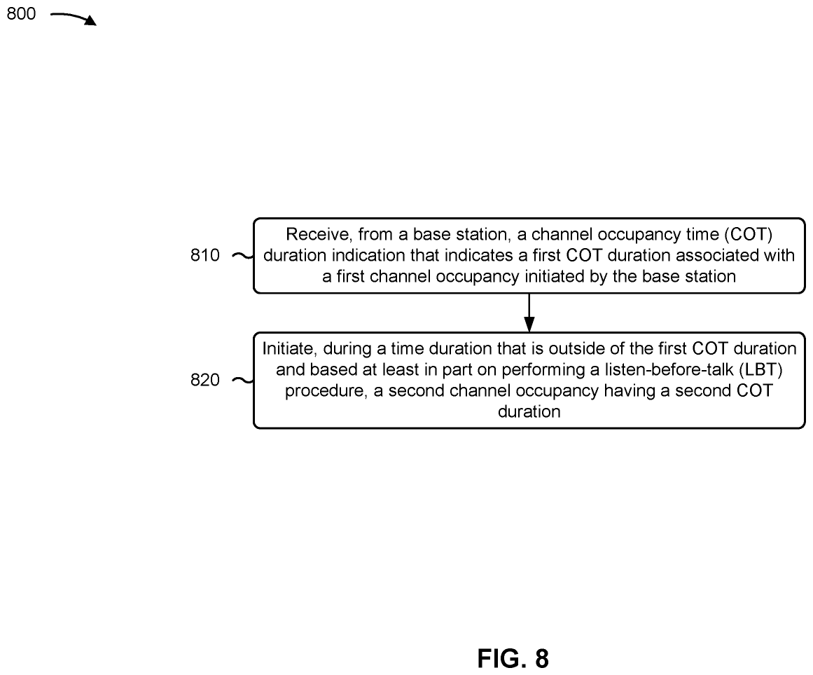

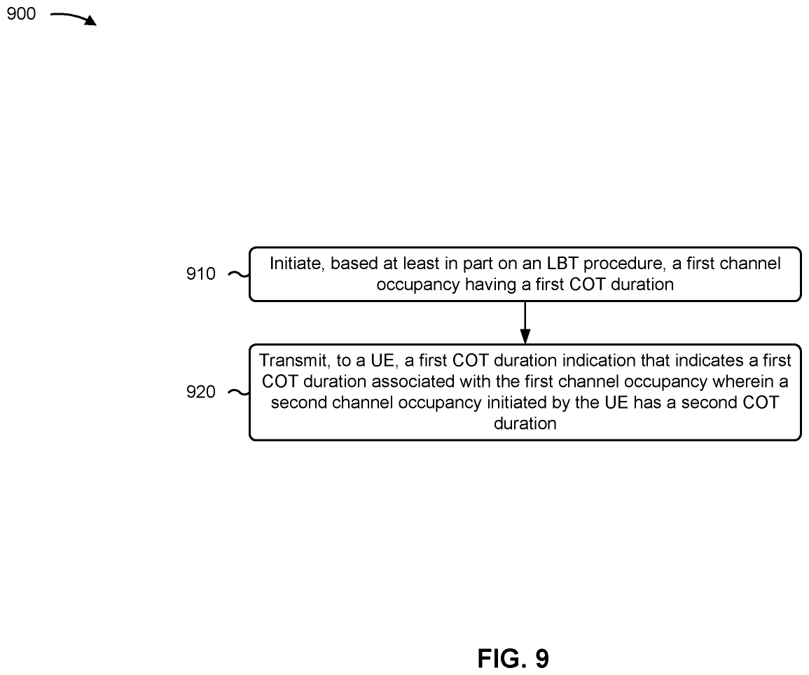

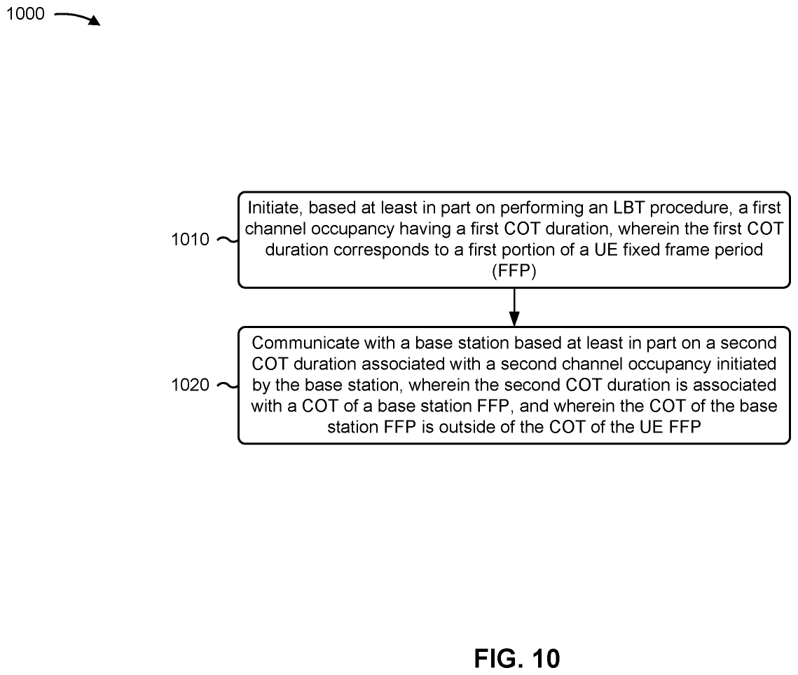

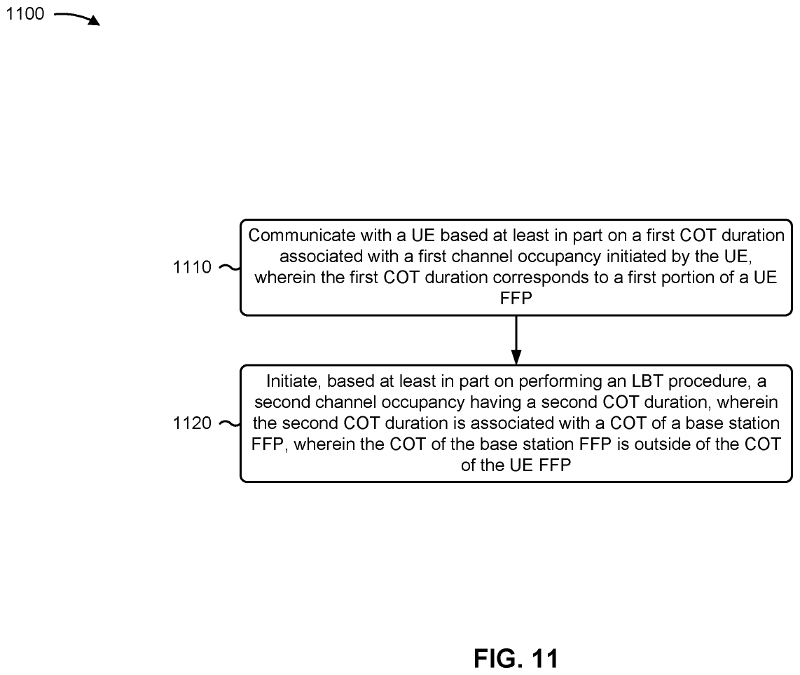

Controller/processor 240 of base station 110, controller/processor 280 of UE 120, and/or any other component(s) of FIG. 2 may perform one or more techniques associated with UE initiated channel occupancy time (COT) configuration and indication, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some aspects, executing instructions may include running the instructions, converting the instructions, compiling the instructions, and/or interpreting the instructions.

In some aspects, the UE includes means for receiving, from a base station, a COT duration indication that indicates a first COT duration associated with a first channel occupancy initiated by the base station; and/or means for initiating, during a time duration that is outside of the first COT duration and based at least in part on performing a listen-before-talk (LBT) procedure, a second channel occupancy having a second COT duration. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for refraining from performing the LBT procedure during the first COT duration.

In some aspects, the UE includes means for refraining from performing the LBT procedure during an idle period of a base station fixed frame period (FFP).

In some aspects, the UE includes means for receiving a COT configuration that indicates at least one parameter, wherein the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, the base station includes means for initiating, based at least in part on an LBT procedure, a first channel occupancy having a first COT duration; and/or means for transmitting, to a UE, a first COT duration indication that indicates a first COT duration associated with the first channel occupancy, wherein a second channel occupancy initiated by the UE has a second COT duration. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the base station includes means for transmitting a COT configuration that indicates at least one parameter, wherein the at least one parameter comprises at least one of: an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

In some aspects, the UE includes means for initiating, based at least in part on performing an LBT procedure, a first channel occupancy having a first COT duration, wherein the first COT duration corresponds to a first portion of a UE FFP; and/or means for communicating with a base station based at least in part on a second COT duration associated with a second channel occupancy initiated by the base station, wherein the second COT duration is associated with a COT of a base station FFP, and wherein the COT of the base station FFP is outside of the COT of the UE FFP. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for receiving, from the base station, a COT duration indication that indicates the first COT duration.

In some aspects, the UE includes means for transmitting, to the base station, a COT duration indication that indicates the first COT duration.

In some aspects, the base station includes means for communicating with a UE based at least in part on a first COT duration associated with a first channel occupancy initiated by the UE, wherein the first COT duration corresponds to a first portion of a UE FFP; and/or means for initiating, based at least in part on performing an LBT procedure, a second channel occupancy having a second COT duration, wherein the second COT duration is associated with a COT of a base station FFP, wherein the COT of the base station FFP is outside of the COT of the UE FFP. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the base station includes means for transmitting, to the UE, a COT duration indication that indicates the first COT duration.

In some aspects, the base station includes means for receiving, from the UE, a COT duration indication that indicates the first COT duration.

In some aspects, the base station includes means for terminating the second COT duration at a boundary of a base station FFP.

As indicated above, FIG. 2 is provided as an example. Other examples may differ from what is described with regard to FIG. 2.

A wireless communication device (e.g., a UE 120 or a base station 110, among other examples) may be capable of operating in a semi-static channel access mode that permits the wireless communication device to attempt to utilize radio resources (e.g., radio resources in an unlicensed spectrum) needed for transmitting or receiving communications. In the context of the semi-static channel access mode, a wireless communication device that initiates a COT acquisition associated with occupying radio resources (sometimes referred to as an initiating device) is associated with a single FFP. The FFP is used for initiating channel occupancy purposes and is defined by an FFP period and an FFP offset.

A wireless communication device that initiates a COT acquisition may be said to initiate a channel occupancy. A wireless communication device may initiate a channel occupancy based at least in part on an LBT procedure. In some cases, a base station may provide a COT structure indicator (COT-SI) that may indicate one or more parameters associated with a COT. For example, the base station may transmit a slot format indicator (SFI) downlink control information (DCI) (e.g., a DCI Format 2_0) transmission that indicates the COT structure in the time and/or frequency domains.

In some cases, a bitmap may be used to indicate available LBT bandwidths. The indication of available LBT bandwidths may be valid until the end of the channel occupancy. A COT duration bit-field per serving cell may be used to indicate a remaining length from the beginning of a slot where the information is received. In some cases, a number of parameters may be configured using radio resource control (RRC) messages. The parameters may include, for example, a presence of the COT duration bit-field, a location of the bit-field in the DCI, and/or a set of values for the COT duration, among other examples. For example, in some cases, the bit field indicates the COT duration as an index to the set of values.

In some cases, if the bit-field is not present (e.g., by configuration), the UE can use the SFI indication to determine end-of-COT (if SFI is available). The UE may assume that the duration of the COT is the same as the duration for which SFI is provided in DCI format 2_0. When a UE receives a COT duration indication with a given symbol being within the COT duration, the UE is not expected to receive a subsequent COT duration indication that indicates that symbol to not be within the COT duration.

In some cases, a UE that transmits as a responding FFP device can use an FFP configuration of an initiating COT base station for the duration of the base station FFP. It may be useful for the UE to initiate a channel occupancy, but in some cases, the UE may not itself initiate another COT for the duration of the current initiating device FFP unless explicitly allowed by the base station. In some cases, it may be unclear whether the UE can initiate a channel occupancy during a base station FFP and/or how the UE may determine that the UE can initiate the channel occupancy, which may result in inefficient use of network resources, thereby having a negative impact on network performance.

Some aspects of techniques and apparatuses described herein may facilitate UE initiated COT configuration and indication. For example, in some aspects, a base station may provide, to the UE, a COT duration indication that indicates a first COT duration associated with a first channel occupancy initiated by the base station. The UE may initiate, during a time duration that is outside of the first COT duration and based at least in part on performing an LBT procedure, a second channel occupancy having a second COT duration. In this way, some aspects may facilitate dynamic switching of UE behavior to initiate channel occupancy when the base station does not initiate channel occupancy. Similarly, the base station may dynamically initiate channel occupancy outside of UE COT.

To facilitate the dynamic initiation of channel occupancy described above, some aspects include techniques for indicating COT durations. For example, the base station may configure the UE with COT durations, the UE may indicate a COT duration to the base station, and/or the base station may indicate a COT duration. In this way, some aspects facilitate indication of COT durations between a UE and a base station, thereby facilitating the dynamic initiation of channel occupancy. As a result, some aspects may facilitate more efficient use of network resources, which may have a positive effect on network performance.

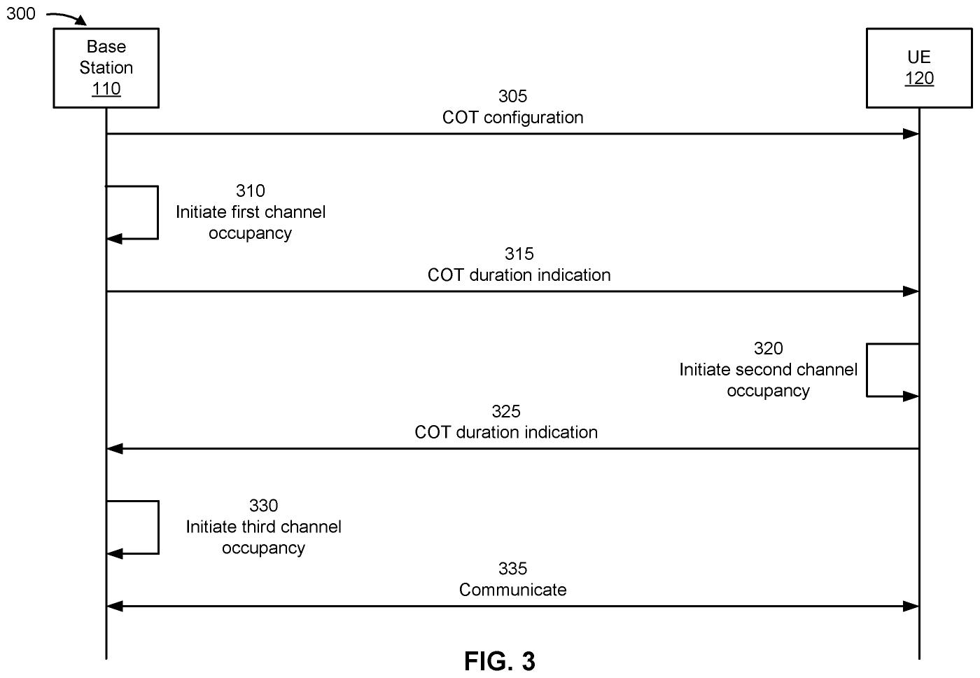

FIG. 3 is a diagram illustrating an example 300 associated with UE initiated COT configuration and indication, in accordance with the present disclosure. As shown in FIG. 3, a base station 110 and a UE 120 may communicate with one another.

As show by reference number 305, the base station 110 may transmit, and the UE 120 may receive, a COT configuration. The COT configuration may be carried, for example, using an RRC message. The COT configuration may include any number of parameters associated with an LBT procedure and/or one or more parameters associated with initiating channel occupancy, among other examples.

In some aspects, for example, the COT configuration indicates at least one parameter. The at least one parameter may configure at least one UE behavior. For example, the at least one parameter may include an indication that the UE 120 is allowed to initiate the second channel occupancy during a base station FFP based at least in part on the base station initiating the first channel occupancy during the base station FFP, an indication that the UE 120 is not allowed to initiate the second channel occupancy during a base station FFP based at least in part on the base station initiating the first channel occupancy during the base station FFP, and/or an indication that the UE 120 is allowed to initiate the second channel occupancy during a base station FFP based at least in part on the first COT duration, where the first channel occupancy was initiated during the base station FFP. In some aspects, one or more of the parameters discussed above may be pre-configured, specified in a wireless communication standard, and/or indicated using a dynamic communication, among other examples.

As shown by reference number 310, the base station 110 may initiate, based at least in part on an LBT procedure, a first channel occupancy having a first COT duration. As shown by reference number 315, the base station 110 may transmit, and the UE 120 may receive, a COT duration indication. The COT duration indication may indicate a first COT duration associated with the first channel occupancy initiated by the base station 110. In this way, some aspects may facilitate supporting dynamic switching of UE 120 behavior between initiating channel occupancy and not initiating channel occupancy.

In some aspects, the COT duration indication may be carried using DCI. The DCI may include the first COT duration indication. In some aspects, for example, the DCI may include a DCI format 2_0 transmission. The COT duration indication may be transmitted using COT-SI. In some aspects, the DCI may include an uplink resource grant. In some aspects, the COT duration indication may be carried using an RRC message.

As shown by reference number 320, the UE 120 may initiate, during a time duration that is outside of the first COT duration and based at least in part on performing an LBT procedure, a second channel occupancy having a second COT duration. In some aspects, the first COT duration and the second COT duration may be at least approximately equal, and in other aspects, the first COT duration and the second COT duration may be different.

In some aspects, the first COT duration may be associated with a COT of a base station FFP, where the second COT duration may be associated with a COT of a UE FFP. The COT of the UE FFP may be outside of the COT of the base station FFP. The UE 120 may refrain from performing the LBT procedure during the first COT duration. In some aspects, the UE 120 may refrain from performing the LBT procedure during an idle period of a base station FFP. In some aspects, the base station 110 may prevent the UE 120 from initiating channel occupancy by setting its COT duration equal to a duration of the base station FFP.

To facilitate further dynamic behavior of the base station 110, the base station 110 may know the UE COT duration. As shown by reference number 325, for example, the UE 120 may transmit, and the base station 110 may receive, a second COT duration indication that indicates the second COT duration. In some aspects, the UE 120 may transmit the second COT duration indication using a CG-UCI transmission. The COT duration indication may include a COT sharing information field of the CG-UCI transmission. For example, the UE 120 may reuse the COT sharing information field of the CG-UCI transmission. In other aspects, the UE 120 may use a new, dedicated COT duration indication field of the CG-UCI transmission.

In some aspects, the base station 110 may configure the UE COT duration (e.g., the second COT duration). For example, the base station 110 may indicate the UE COT duration in an RRC message or a DCI transmission (e.g., as part of an uplink grant). In some aspects, the base station 110 may be configured with implementation-based restrictions. For example, in some aspects, the scenario in which the UE 120 may initiate channel occupancy may be referred to as a COT sharing scenario (because the base station 110 is sharing the ability to initiate COT with the UE 120). In some aspects, the base station 110 may be configured to stop COT sharing at a base station FFP boundary.

As shown by reference number 330, the base station 110 may initiate a third channel occupancy based at least in part on an LBT procedure during a COT duration that is outside of the second COT duration. As shown by reference number 335, the base station 110 and the UE 120 may communicate based at least in part on the third channel occupancy. In some aspects, the base station 110 and the UE 120 may communicate based at least in part on any of the first, second, or third COT durations, among other examples.

As indicated above, FIG. 3 is provided as an example. Other examples may differ from what is described with respect to FIG. 3.

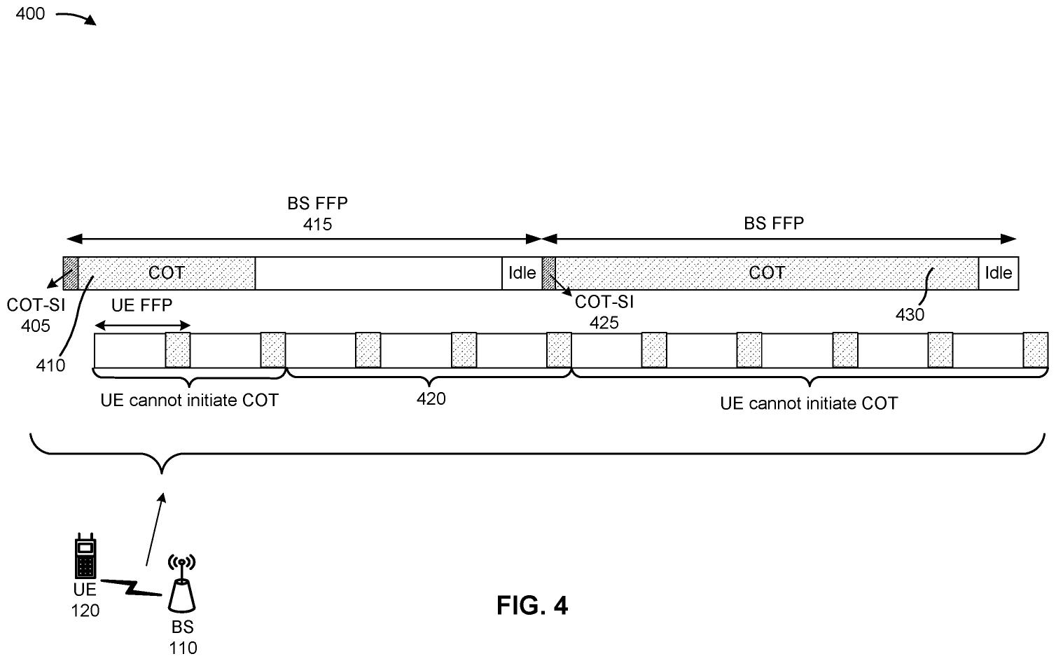

FIG. 4 is a diagram illustrating an example 400 associated with UE initiated COT configuration and indication, in accordance with the present disclosure. As shown in FIG. 4, a base station 110 and a UE 120 may communicate with one another. The base station 110 and the UE 120 may communicate in accordance with one or more aspects described above in connection with FIG. 3.

As show by reference number 405, the base station 110 may transmit a first COT-SI to the UE 120. The COT-SI may indicate a COT duration corresponding to a first base station COT 410 corresponding to a first base station (shown as “B S”) FFP 415. The UE 120 may refrain from initiating channel occupancy during the first COT 410. In some aspects, the UE 120 may initiate channel occupancy at any time outside of the first COT 410 (e.g., during the time period 420). As shown by reference number 425, the base station 110, after an idle period, may transmit a second COT-SI that indicates a COT duration corresponding to a second base station COT 430. Again, the UE 120 may refrain from initiating channel occupancy during the second COT duration. In this way, the UE 120 COT may not overlap base station 110 COT, and the UE 120 may dynamically initiate channel occupancy when the base station 110 is not occupying a channel.

As indicated above, FIG. 4 is provided as an example. Other examples may differ from what is described with respect to FIG. 4.

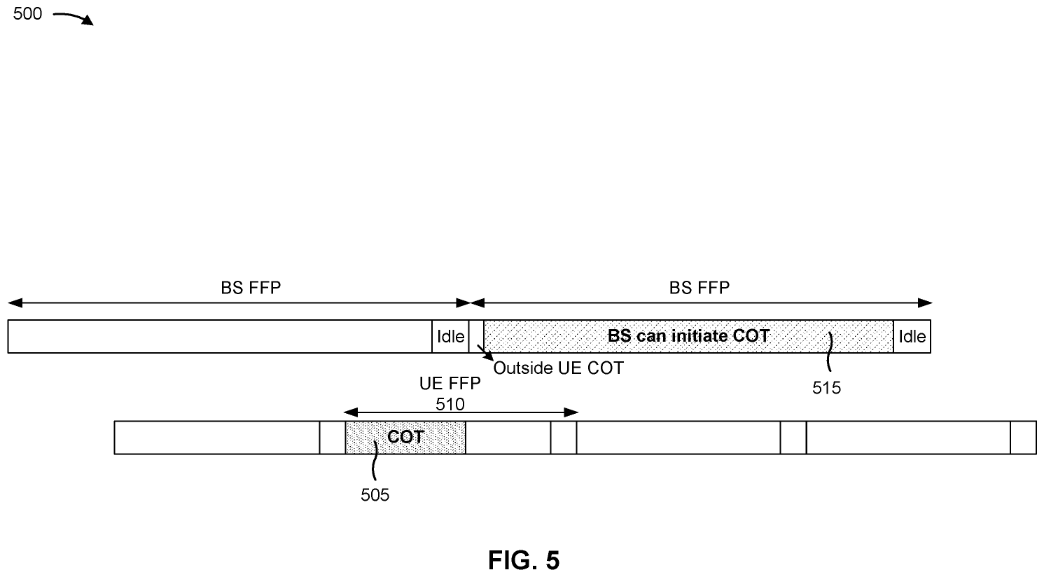

FIG. 5 is a diagram illustrating an example 500 associated with UE initiated COT configuration and indication, in accordance with the present disclosure. As shown in FIG. 5, a base station 110 and a UE 120 may communicate with one another. The base station 110 and the UE 120 may communicate in accordance with one or more aspects described above in connection with FIGS. 3 and/or 4.

Example 500 shows an example of a COT configuration in which the UE 120 initiates a COT 505 corresponding to a UE FFP 510. As shown by reference number 515, the base station 110 is allowed to initiate channel occupancy (e.g., initiate a COT) outside of the UE COT 505.

As indicated above, FIG. 5 is provided as an example. Other examples may differ from what is described with respect to FIG. 5.

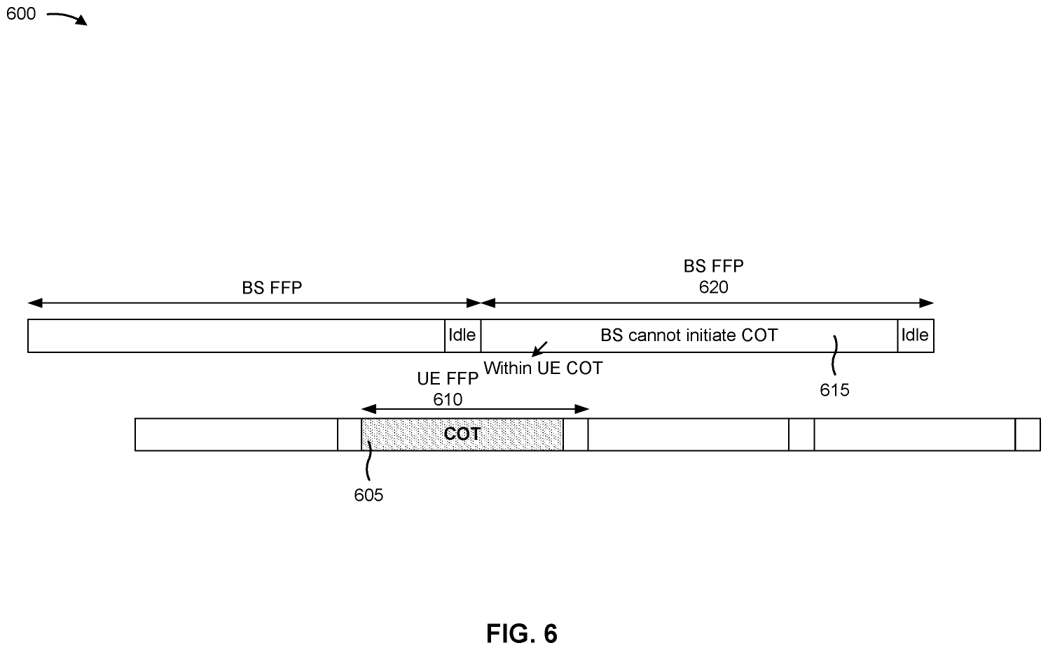

FIG. 6 is a diagram illustrating an example 600 associated with UE initiated COT configuration and indication, in accordance with the present disclosure. As shown in FIG. 6, a base station 110 and a UE 120 may communicate with one another. The base station 110 and the UE 120 may communicate in accordance with one or more aspects described above in connection with FIGS. 3, 4, and/or 5.

Example 600 shows an example of a COT configuration in which the UE 120 initiates a COT 605 corresponding to a UE FFP 610. As shown by reference number 615, the base station 110 is not allowed to initiate channel occupancy (e.g., initiate a COT) within the UE COT 605 or within the base station FFP 620 that overlaps the UE COT 605.

As indicated above, FIG. 6 is provided as an example. Other examples may differ from what is described with respect to FIG. 6.

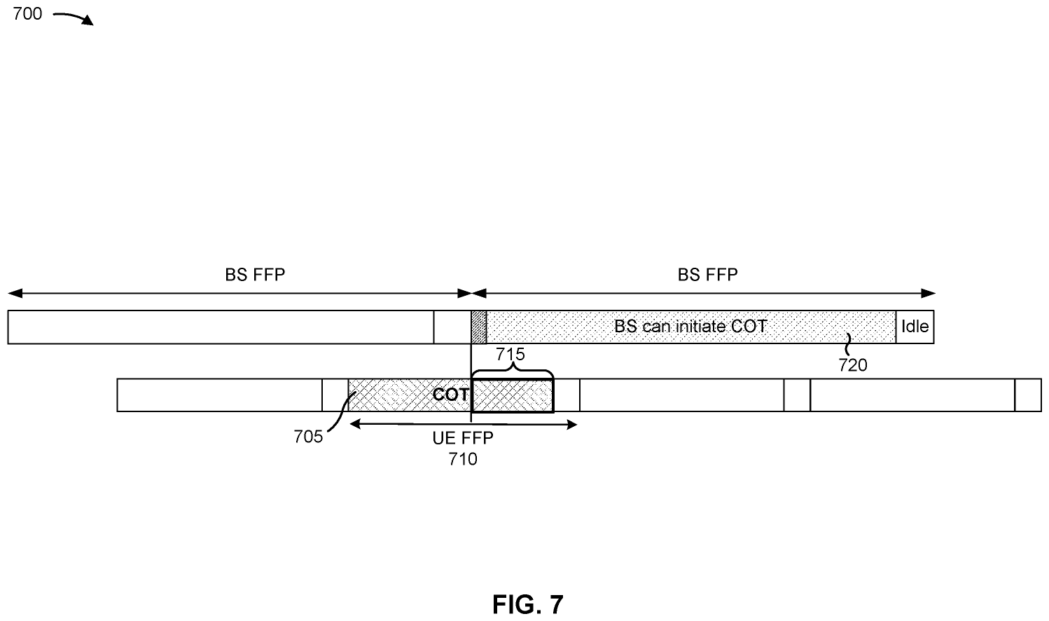

FIG. 7 is a diagram illustrating an example 700 associated with UE initiated COT configuration and indication, in accordance with the present disclosure. As shown in FIG. 7, a base station 110 and a UE 120 may communicate with one another. The base station 110 and the UE 120 may communicate in accordance with one or more aspects described above in connection with FIGS. 3, 4, 5, and/or 6.

Example 700 shows an example of a COT configuration in which the UE 120 initiates a COT 705 corresponding to a UE FFP 710. As shown by reference number 715, the base station 110 may stop COT sharing at a base station FFP boundary. As shown by reference number 720, the base station 110 may initiate COT at any time during the base station FFP following the boundary at which COT sharing was stopped.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with techniques for UE initiated COT configuration and indication.

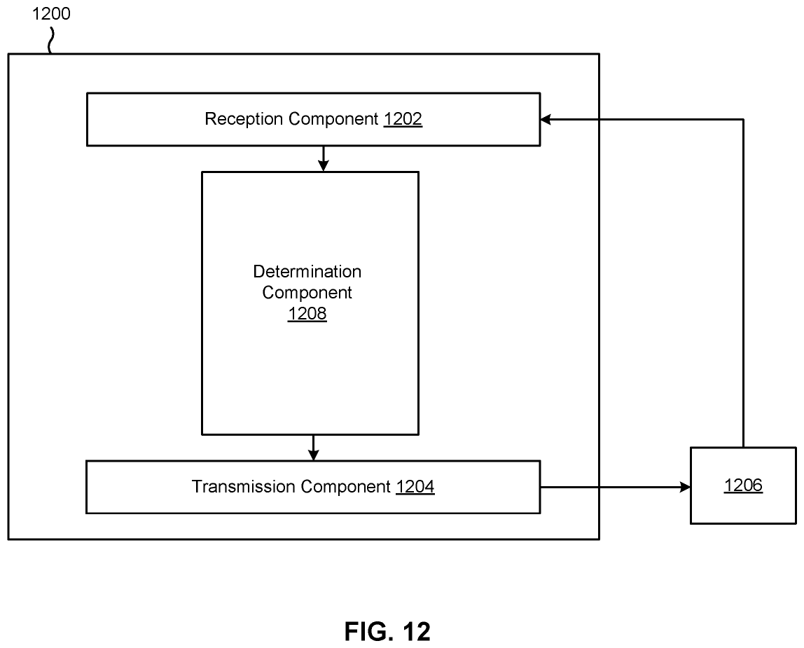

As shown in FIG. 8, in some aspects, process 800 may include receiving, from a base station, a COT duration indication that indicates a first COT duration associated with a first channel occupancy initiated by the base station (block 810). For example, the UE (e.g., using reception component 1202, depicted in FIG. 12) may receive, from a base station, a COT duration indication that indicates a first COT duration associated with a first channel occupancy initiated by the base station, as described above.

As further shown in FIG. 8, in some aspects, process 800 may include initiating, during a time duration that is outside of the first COT duration and based at least in part on performing an LBT procedure, a second channel occupancy having a second COT duration (block 820). For example, the UE (e.g., using reception component 1202, transmission component 1204, and/or determination component 1208, depicted in FIG. 12) may initiate, during a time duration that is outside of the first COT duration and based at least in part on performing an LBT procedure, a second channel occupancy having a second COT duration, as described above.

Process 800 may include additional aspects, such as any single aspect or any combination of aspects described below and/or in connection with one or more other processes described elsewhere herein.

In a first aspect, receiving the COT duration indication comprises receiving DCI that includes the first COT duration indication.

In a second aspect, alone or in combination with the first aspect, the DCI comprises a DCI format 2_0 transmission.

In a third aspect, alone or in combination with one or more of the first and second aspects, the first COT duration is associated with a COT of a base station FFP, wherein the second COT duration is associated with a COT of a UE FFP, and wherein the COT of the UE FFP is outside of the COT of the base station FFP.

In a fourth aspect, alone or in combination with one or more of the first through third aspects, process 800 includes refraining from performing the LBT procedure during the first COT duration.

In a fifth aspect, alone or in combination with one or more of the first through fourth aspects, process 800 includes refraining from performing the LBT procedure during an idle period of a base station FFP.

In a sixth aspect, alone or in combination with one or more of the first through fifth aspects, process 800 includes receiving a COT configuration that indicates at least one parameter, wherein the at least one parameter comprises at least one of an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with techniques for UE initiated COT configuration and indication.

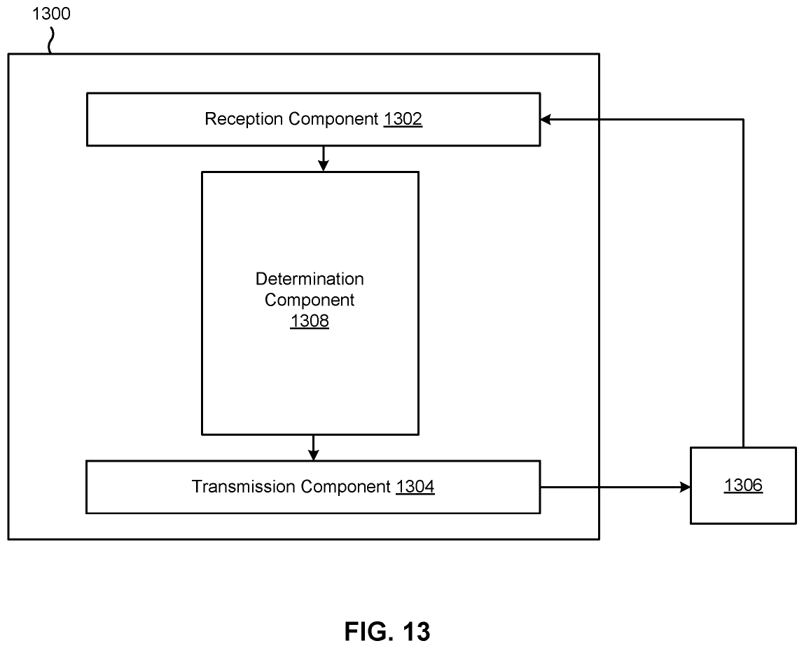

As shown in FIG. 9, in some aspects, process 900 may include initiating, based at least in part on an LBT procedure, a first channel occupancy having a first COT duration (block 910). For example, the base station (e.g., using reception component 1302, transmission component 1304, and/or determination component 1308, depicted in FIG. 13) may initiate, based at least in part on an LBT procedure, a first channel occupancy having a first COT duration, as described above.

As further shown in FIG. 9, in some aspects, process 900 may include transmitting, to a UE, a first COT duration indication that indicates a first COT duration associated with the first channel occupancy, wherein a second channel occupancy initiated by the UE has a second COT duration (block 920). For example, the base station (e.g., using transmission component 1304, depicted in FIG. 13) may transmit, to a UE, a first COT duration indication that indicates a first COT duration associated with the first channel occupancy, wherein a second channel occupancy initiated by the UE has a second COT duration, as described above.

Process 900 may include additional aspects, such as any single aspect or any combination of aspects described below and/or in connection with one or more other processes described elsewhere herein.

In a first aspect, transmitting the first COT duration indication comprises transmitting DCI that includes the first COT duration indication.

In a second aspect, alone or in combination with the first aspect, the DCI comprises a DCI format 2_0 transmission.

In a third aspect, alone or in combination with one or more of the first and second aspects, the first COT duration corresponds to a first portion of a base station FFP, wherein the second COT duration is associated with a COT of a UE FFP, and wherein the COT of the UE FFP is outside of the COT of the base station FFP.

In a fourth aspect, alone or in combination with one or more of the first through third aspects, process 900 includes transmitting a COT configuration that indicates at least one parameter, wherein the at least one parameter comprises at least one of an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with techniques for UE initiated COT configuration and indication.

As shown in FIG. 10, in some aspects, process 1000 may include initiating, based at least in part on performing an LBT procedure, a first channel occupancy having a first COT duration, wherein the first COT duration corresponds to a first portion of a UE FFP (block 1010). For example, the UE (e.g., using reception component 1202, transmission component 1204, and/or determination component 1208, depicted in FIG. 12) may initiate, based at least in part on performing an LBT procedure, a first channel occupancy having a first COT duration, wherein the first COT duration corresponds to a first portion of a UE FFP, as described above.

As further shown in FIG. 10, in some aspects, process 1000 may include communicating with a base station based at least in part on a second COT duration associated with a second channel occupancy initiated by the base station, wherein the second COT duration is associated with a COT of a base station FFP, and wherein the COT of the base station FFP is outside of the COT of the UE FFP (block 1020). For example, the UE (e.g., using reception component 1202 and/or transmission component 1204, depicted in FIG. 12) may communicate with a base station based at least in part on a second COT duration associated with a second channel occupancy initiated by the base station, wherein the second COT duration is associated with a COT of a base station FFP, and wherein the COT of the base station FFP is outside of the COT of the UE FFP, as described above.

Process 1000 may include additional aspects, such as any single aspect or any combination of aspects described below and/or in connection with one or more other processes described elsewhere herein.

In a first aspect, process 1000 includes receiving, from the base station, a COT duration indication that indicates the first COT duration.

In a second aspect, alone or in combination with the first aspect, receiving the COT duration indication comprises receiving a radio resource control message including a configuration that includes the first COT duration indication.

In a third aspect, alone or in combination with one or more of the first and second aspects, receiving the COT duration indication comprises receiving a DCI transmission that includes the COT duration indication.

In a fourth aspect, alone or in combination with one or more of the first through third aspects, the DCI comprises an uplink resource grant.

In a fifth aspect, alone or in combination with one or more of the first through fourth aspects, process 1000 includes transmitting, to the base station, a COT duration indication that indicates the first COT duration.

In a sixth aspect, alone or in combination with one or more of the first through fifth aspects, transmitting the COT duration indication comprises transmitting a CG-UCI transmission that includes the COT duration indication.

In a seventh aspect, alone or in combination with one or more of the first through sixth aspects, the COT duration indication comprises a COT sharing information field of the CG-UCI transmission, or a dedicated COT duration indication field of the CG-UCI transmission.

In an eighth aspect, alone or in combination with one or more of the first through seventh aspects, the second COT duration terminates at a boundary of a base station FFP.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with the present disclosure. Example process 1100 is an example where the base station (e.g., base station 110) performs operations associated with techniques for UE initiated COT configuration and indication.

As shown in FIG. 11, in some aspects, process 1100 may include communicating with a UE based at least in part on a first COT duration associated with a first channel occupancy initiated by the UE, wherein the first COT duration corresponds to a first portion of a UE FFP (block 1110). For example, the base station (e.g., using reception component 1302 and/or transmission component 1304, depicted in FIG. 13) may communicate with a UE based at least in part on a first COT duration associated with a first channel occupancy initiated by the UE, wherein the first COT duration corresponds to a first portion of a UE FFP, as described above.

As further shown in FIG. 11, in some aspects, process 1100 may include initiating, based at least in part on performing an LBT procedure, a second channel occupancy having a second COT duration, wherein the second COT duration is associated with a COT of a base station FFP, wherein the COT of the base station FFP is outside of the COT of the UE FFP (block 1120). For example, the base station (e.g., using reception component 1302, transmission component 1304, and/or determination component 1308, depicted in FIG. 13) may initiate, based at least in part on performing an LBT procedure, a second channel occupancy having a second COT duration, wherein the second COT duration is associated with a COT of a base station FFP, wherein the COT of the base station FFP is outside of the COT of the UE FFP, as described above.

Process 1100 may include additional aspects, such as any single aspect or any combination of aspects described below and/or in connection with one or more other processes described elsewhere herein.

In a first aspect, process 1100 includes transmitting, to the UE, a COT duration indication that indicates the first COT duration.

In a second aspect, alone or in combination with the first aspect, transmitting the COT duration indication comprises transmitting a radio resource control message including a configuration that includes the first COT duration indication.

In a third aspect, alone or in combination with one or more of the first and second aspects, transmitting the COT duration indication comprises transmitting a DCI transmission that includes the COT duration indication.

In a fourth aspect, alone or in combination with one or more of the first through third aspects, the DCI comprises an uplink resource grant.

In a fifth aspect, alone or in combination with one or more of the first through fourth aspects, process 1100 includes receiving, from the UE, a COT duration indication that indicates the first COT duration.

In a sixth aspect, alone or in combination with one or more of the first through fifth aspects, receiving the COT duration indication comprises receiving a CG-UCI transmission that includes the COT duration indication.

In a seventh aspect, alone or in combination with one or more of the first through sixth aspects, the COT duration indication comprises a COT sharing information field of the CG-UCI transmission, or a dedicated COT duration indication field of the CG-UCI transmission.

In an eighth aspect, alone or in combination with one or more of the first through seventh aspects, process 1100 includes terminating the second COT duration at a boundary of a base station FFP.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a block diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a determination component 1208.

In some aspects, the apparatus 1200 may be configured to perform one or more operations described herein in connection with FIGS. 3-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the UE described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the UE described above in connection with FIG. 2. In some aspects, the transmission component 1204 may be co-located with the reception component 1202 in a transceiver.

The reception component 1202 may receive, from a base station, a COT duration indication that indicates a first COT duration associated with a first channel occupancy initiated by the base station. The reception component 1202, transmission component 1204, and/or determination component 1208 may initiate, during a time duration that is outside of the first COT duration and based at least in part on performing an LBT procedure, a second channel occupancy having a second COT duration. In some aspects, the determination component 1208 may include one or more antennas, a modulator, a transmit MIMO processor, a transmit processor, a controller/processor, a memory, or a combination thereof, of the UE described above in connection with FIG. 2. In some aspects, the determination component 1208 may include the reception component 1202 and/or the transmission component 1204.

The reception component 1202, transmission component 1204, and/or determination component 1208 may refrain from performing the LBT procedure during the first COT duration. The reception component 1202, transmission component 1204, and/or determination component 1208 may refrain from performing the LBT procedure during an idle period of a base station FFP.

The reception component 1202 may receive a COT configuration that indicates at least one parameter, wherein the at least one parameter comprises at least one of an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

The reception component 1202, transmission component 1204, and/or determination component 1208 may initiate, based at least in part on performing an LBT procedure, a first channel occupancy having a first COT duration, wherein the first COT duration corresponds to a first portion of a UE FFP. The reception component 1202, transmission component 1204, and/or determination component 1208 may communicate with a base station based at least in part on a second COT duration associated with a second channel occupancy initiated by the base station, wherein the second COT duration is associated with a COT of a base station FFP, and wherein the COT of the base station FFP is outside of the COT of the UE FFP.

The reception component 1202 may receive, from the base station, a COT duration indication that indicates the first COT duration.

The transmission component 1204 may transmit, to the base station, a COT duration indication that indicates the first COT duration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a base station, or a base station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a determination component 1308.

In some aspects, the apparatus 1300 may be configured to perform one or more operations described herein in connection with FIGS. 3-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the base station described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the base station described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the base station described above in connection with FIG. 2. In some aspects, the transmission component 1304 may be co-located with the reception component 1302 in a transceiver.

The reception component 1302, transmission component 1304, and/or determination component 1308 may initiate, based at least in part on an LBT procedure, a first channel occupancy having a first COT duration. The transmission component 1304 may transmit, to a UE, a first COT duration indication that indicates a first COT duration associated with the first channel occupancy wherein a second channel occupancy initiated by the UE has a second COT duration. In some aspects, the determination component 1308 may include one or more antennas, a modulator, a transmit MIMO processor, a transmit processor, a controller/processor, a memory, or a combination thereof, of the base station described above in connection with FIG. 2. In some aspects, the determination component 1308 may include the reception component 1302 and/or the transmission component 1304.

The transmission component 1304 may transmit a COT configuration that indicates at least one parameter, wherein the at least one parameter comprises at least one of an indication that the UE is allowed to initiate the second channel occupancy during a base station FFP based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

The reception component 1302 and/or the transmission component 1304 may communicate with a UE based at least in part on a first COT duration associated with a first channel occupancy initiated by the UE, wherein the first COT duration corresponds to a first portion of a UE FFP. The reception component 1302, transmission component 1304, and/or determination component 1308 may initiate, based at least in part on performing an LBT procedure, a second channel occupancy having a second COT duration, wherein the second COT duration is associated with a COT of a base station FFP, wherein the COT of the base station FFP is outside of the COT of the UE FFP.

The transmission component 1304 may transmit, to the UE, a COT duration indication that indicates the first COT duration.

The reception component 1302 may receive, from the UE, a COT duration indication that indicates the first COT duration.

The reception component 1302, transmission component 1304, and/or determination component 1308 may terminate the second COT duration at a boundary of a base station FFP.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a base station, a channel occupancy time (COT) duration indication that indicates a first COT duration associated with a first channel occupancy initiated by the base station; and initiating, during a time duration that is outside of the first COT duration and based at least in part on performing a listen-before-talk (LBT) procedure, a second channel occupancy having a second COT duration.

Aspect 2: The method of Aspect 1, wherein receiving the COT duration indication comprises receiving downlink control information (DCI) that includes the first COT duration indication.

Aspect 3: The method of Aspect 2, wherein the DCI comprises a DCI format 2_0 transmission.

Aspect 4: The method of any of Aspects 1-3, wherein the first COT duration corresponds to a first portion of a base station fixed frame period (FFP), wherein the second COT duration is associated with a COT of a UE FFP, and wherein the COT of the UE FFP is outside of the COT of the base station FFP.

Aspect 5: The method of any of Aspects 1-4, further comprising refraining from performing the LBT procedure during the first COT duration.

Aspect 6: The method of any of Aspects 1-5, further comprising refraining from performing the LBT procedure during an idle period of a base station fixed frame period (FFP).

Aspect 7: The method of any of Aspects 1-6, further comprising receiving a COT configuration that indicates at least one parameter, wherein the at least one parameter comprises at least one of: an indication that the UE is allowed to initiate the second channel occupancy during a base station fixed frame period (FFP) based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

Aspect 8: A method of wireless communication performed by a base station, comprising: initiating, based at least in part on a listen-before-talk (LBT) procedure, a first channel occupancy having a first channel occupancy time (COT) duration; and transmitting, to a user equipment (UE), a first COT duration indication that indicates a first COT duration associated with the first channel occupancy, wherein a second channel occupancy initiated by the UE has a second COT duration.

Aspect 9: The method of Aspect 8, wherein transmitting the first COT duration indication comprises transmitting downlink control information (DCI) that includes the first COT duration indication.

Aspect 10: The method of Aspect 9, wherein the DCI comprises a DCI format 2_0 transmission.

Aspect 11: The method of any of Aspects 8-10, wherein the first COT duration corresponds to a first portion of a base station fixed frame period (FFP), wherein the second COT duration is associated with a COT of a UE FFP, and wherein the COT of the UE FFP is outside of the COT of the base station FFP.

Aspect 12: The method of any of Aspects 8-11, further comprising transmitting a COT configuration that indicates at least one parameter, wherein the at least one parameter comprises at least one of: an indication that the UE is allowed to initiate the second channel occupancy during a base station fixed frame period (FFP) based at least in part on the base station initiating the first channel occupancy during the base station FFP, an indication that the UE is not allowed to initiate the second channel occupancy during a base station FFP based at least in part on the base station initiating the first channel occupancy during the base station FFP, or an indication that the UE is allowed to initiate the second channel occupancy during a base station FFP based at least in part on the first COT duration, wherein the first channel occupancy was initiated during the base station FFP.

Aspect 13: A method of wireless communication performed by a user equipment (UE), comprising: initiating, based at least in part on performing a listen-before-talk (LBT) procedure, a first channel occupancy having a first channel occupancy time (COT) duration, wherein the first COT duration corresponds to a first portion of a UE fixed frame period (FFP); and communicating with a base station based at least in part on a second COT duration associated with a second channel occupancy initiated by the base station, wherein the second COT duration is associated with a COT of a base station FFP, and wherein the COT of the base station FFP is outside of the COT of the UE FFP.

Aspect 14: The method of Aspect 13, further comprising receiving, from the base station, a COT duration indication that indicates the first COT duration.

Aspect 15: The method of Aspect 14, wherein receiving the COT duration indication comprises receiving a radio resource control message including a configuration that includes the first COT duration indication.

Aspect 16: The method of Aspect 14, wherein receiving the COT duration indication comprises receiving a downlink control information (DCI) transmission that includes the COT duration indication.

Aspect 17: The method of Aspect 16, wherein the DCI comprises an uplink resource grant.

Aspect 18: The method of Aspect 13, further comprising transmitting, to the base station, a COT duration indication that indicates the first COT duration.

Aspect 19: The method of Aspect 18, wherein transmitting the COT duration indication comprises transmitting a configured grant (CG)-uplink control information (CG-UCI) transmission that includes the COT duration indication.

Aspect 20: The method of Aspect 19, wherein the COT duration indication comprises: a COT sharing information field of the CG-UCI transmission, or a dedicated COT duration indication field of the CG-UCI transmission.

Aspect 21: The method of any of Aspects 13-21, wherein the second COT duration terminates at a boundary of a base station FFP.

Aspect 22: A method of wireless communication performed by a base station, comprising: communicating with a user equipment (UE) based at least in part on a first channel occupancy time (COT) duration associated with a first channel occupancy initiated by the UE, wherein the first COT duration corresponds to a first portion of a UE fixed frame period (FFP); and initiating, based at least in part on performing a listen-before-talk (LBT) procedure, a second channel occupancy having a second COT duration, wherein the second COT duration is associated with a COT of a base station FFP, and wherein the COT of the base station FFP is outside of the COT of the UE FFP.

Aspect 23: The method of Aspect 22, further comprising transmitting, to the UE, a COT duration indication that indicates the first COT duration.

Aspect 24: The method of Aspect 23, wherein transmitting the COT duration indication comprises transmitting a radio resource control message including a configuration that includes the first COT duration indication.

Aspect 25: The method of Aspect 23, wherein transmitting the COT duration indication comprises transmitting a downlink control information (DCI) transmission that includes the COT duration indication.

Aspect 26: The method of Aspect 25, wherein the DCI comprises an uplink resource grant.

Aspect 27: The method of Aspect 22, further comprising receiving, from the UE, a COT duration indication that indicates the first COT duration.

Aspect 28: The method of Aspect 27, wherein receiving the COT duration indication comprises receiving a configured grant (CG)-uplink control information (CG-UCI) transmission that includes the COT duration indication.

Aspect 29: The method of Aspect 28, wherein the COT duration indication comprises: a COT sharing information field of the CG-UCI transmission, or a dedicated COT duration indication field of the CG-UCI transmission.

Aspect 30: The method of any of Aspects 22-29, further comprising terminating the second COT duration at a boundary of a base station FFP.

Aspect 31: An apparatus for wireless communication at a device, comprising a processor; memory coupled with the processor; and instructions stored in the memory and executable by the processor to cause the apparatus to perform the method of one or more Aspects of Aspects 1-7.

Aspect 32: A device for wireless communication, comprising a memory and one or more processors coupled to the memory, the memory and the one or more processors configured to perform the method of one or more Aspects of Aspects 1-7.

Aspect 33: An apparatus for wireless communication, comprising at least one means for performing the method of one or more Aspects of Aspects 1-7.

Aspect 34: A non-transitory computer-readable medium storing code for wireless communication, the code comprising instructions executable by a processor to perform the method of one or more Aspects of Aspects 1-7.

Aspect 35: A non-transitory computer-readable medium storing a set of instructions for wireless communication, the set of instructions comprising one or more instructions that, when executed by one or more processors of a device, cause the device to perform the method of one or more Aspects of Aspects 1-7.

Aspect 36: An apparatus for wireless communication at a device, comprising a processor; memory coupled with the processor; and instructions stored in the memory and executable by the processor to cause the apparatus to perform the method of one or more Aspects of Aspects 8-12.

Aspect 37: A device for wireless communication, comprising a memory and one or more processors coupled to the memory, the memory and the one or more processors configured to perform the method of one or more Aspects of Aspects 8-12.

Aspect 38: An apparatus for wireless communication, comprising at least one means for performing the method of one or more Aspects of Aspects 8-12.

Aspect 39: A non-transitory computer-readable medium storing code for wireless communication, the code comprising instructions executable by a processor to perform the method of one or more Aspects of Aspects 8-12.

Aspect 40: A non-transitory computer-readable medium storing a set of instructions for wireless communication, the set of instructions comprising one or more instructions that, when executed by one or more processors of a device, cause the device to perform the method of one or more Aspects of Aspects 8-12.

Aspect 41: An apparatus for wireless communication at a device, comprising a processor; memory coupled with the processor; and instructions stored in the memory and executable by the processor to cause the apparatus to perform the method of one or more Aspects of Aspects 13-21.

Aspect 42: A device for wireless communication, comprising a memory and one or more processors coupled to the memory, the memory and the one or more processors configured to perform the method of one or more Aspects of Aspects 13-21.

Aspect 43: An apparatus for wireless communication, comprising at least one means for performing the method of one or more Aspects of Aspects 13-21.

Aspect 44: A non-transitory computer-readable medium storing code for wireless communication, the code comprising instructions executable by a processor to perform the method of one or more Aspects of Aspects 13-21.

Aspect 45: A non-transitory computer-readable medium storing a set of instructions for wireless communication, the set of instructions comprising one or more instructions that, when executed by one or more processors of a device, cause the device to perform the method of one or more Aspects of Aspects 13-21.

Aspect 46: An apparatus for wireless communication at a device, comprising a processor; memory coupled with the processor; and instructions stored in the memory and executable by the processor to cause the apparatus to perform the method of one or more Aspects of Aspects 22-30.

Aspect 47: A device for wireless communication, comprising a memory and one or more processors coupled to the memory, the memory and the one or more processors configured to perform the method of one or more Aspects of Aspects 22-30.

Aspect 48: An apparatus for wireless communication, comprising at least one means for performing the method of one or more Aspects of Aspects 22-30.

Aspect 49: A non-transitory computer-readable medium storing code for wireless communication, the code comprising instructions executable by a processor to perform the method of one or more Aspects of Aspects 22-30.

Aspect 50: A non-transitory computer-readable medium storing a set of instructions for wireless communication, the set of instructions comprising one or more instructions that, when executed by one or more processors of a device, cause the device to perform the method of one or more Aspects of Aspects 22-30.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a base station, a channel occupancy time (COT) duration indication that indicates a first COT duration associated with a first channel occupancy initiated by the base station; and
initiating, during a time duration that is outside of the first COT duration and based at least in part on performing a listen-before-talk (LBT) procedure, a second channel occupancy having a second COT duration.

2. The method of claim 1, wherein receiving the COT duration indication comprises receiving downlink control information (DCI) that includes the first COT duration indication.

3. The method of claim 2, wherein the DCI comprises a DCI format 2_0 transmission.

4. The method of claim 1, wherein the first COT duration is associated with a COT of a base station fixed frame period (FFP), wherein the second COT duration is associated with a COT of a UE FFP, and wherein the COT of the UE FFP is outside of the COT of the base station FFP.

5. The method of claim 1, further comprising refraining from performing the LBT procedure during the first COT duration.

6. The method of claim 1, further comprising refraining from performing the LBT procedure during an idle period of a base station fixed frame period (FFP).

7. The method of claim 1, further comprising receiving a COT configuration that indicates at least one parameter, wherein the at least one parameter comprises at least one of:
an indication that the UE is allowed to initiate the second channel occupancy during a base station fixed frame period (FFP) based at least in part on the base station initiating the first channel occupancy during the base station FFP,
an indication that the UE is not allowed to initiate the second channel occupancy during a base station FFP based at least in part on the base station initiating the first channel occupancy during the base station FFP, or
an indication that the UE is allowed to initiate the second channel occupancy during a base station FFP based at least in part on the first COT duration, wherein the first channel occupancy was initiated during the base station FFP.

8. A method of wireless communication performed by a base station, comprising:
initiating, based at least in part on a listen-before-talk (LBT) procedure, a first channel occupancy having a first channel occupancy time (COT) duration; and
transmitting, to a user equipment (UE), a first COT duration indication that indicates a first COT duration associated with the first channel occupancy,
wherein a second channel occupancy initiated by the UE has a second COT duration.

9. The method of claim 8, wherein transmitting the first COT duration indication comprises transmitting downlink control information (DCI) that includes the first COT duration indication.

10. The method of claim 9, wherein the DCI comprises a DCI format 2_0 transmission.

11. The method of claim 8, wherein the first COT duration corresponds to a first portion of a base station fixed frame period (FFP), wherein the second COT duration is associated with a COT of a UE FFP, and wherein the COT of the UE FFP is outside of the COT of the base station FFP.

12. The method of claim 8, further comprising transmitting a COT configuration that indicates at least one parameter, wherein the at least one parameter comprises at least one of:
an indication that the UE is allowed to initiate the second channel occupancy during a base station fixed frame period (FFP) based at least in part on the base station initiating the first channel occupancy during the base station FFP,
an indication that the UE is not allowed to initiate the second channel occupancy during a base station FFP based at least in part on the base station initiating the first channel occupancy during the base station FFP, or
an indication that the UE is allowed to initiate the second channel occupancy during a base station FFP based at least in part on the first COT duration, wherein the first channel occupancy was initiated during the base station FFP.

13. A method of wireless communication performed by a user equipment (UE), comprising:
initiating, based at least in part on performing a listen-before-talk (LBT) procedure, a first channel occupancy having a first channel occupancy time (COT) duration, wherein the first COT duration corresponds to a first portion of a UE fixed frame period (FFP); and
communicating with a base station based at least in part on a second COT duration associated with a second channel occupancy initiated by the base station, wherein the second COT duration is associated with a COT of a base station FFP, and wherein the COT of the base station FFP is outside of the COT of a UE FFP.

14. The method of claim 13, further comprising receiving, from the base station, a COT duration indication that indicates the first COT duration.

15. The method of claim 14, wherein receiving the COT duration indication comprises receiving a radio resource control message including a configuration that includes the first COT duration indication.

16. The method of claim 14, wherein receiving the COT duration indication comprises receiving a downlink control information (DCI) transmission that includes the COT duration indication.

17. The method of claim 16, wherein the DCI comprises an uplink resource grant.

18. The method of claim 13, further comprising transmitting, to the base station, a COT duration indication that indicates the first COT duration.

19. The method of claim 18, wherein transmitting the COT duration indication comprises transmitting a configured grant (CG)-uplink control information (CG-UCI) transmission that includes the COT duration indication.

20. The method of claim 19, wherein the COT duration indication comprises:
a COT sharing information field of the CG-UCI transmission, or
a dedicated COT duration indication field of the CG-UCI transmission.

21. The method of claim 13, wherein the second COT duration terminates at a boundary of a base station FFP.

22. A method of wireless communication performed by a base station, comprising:
communicating with a user equipment (UE) based at least in part on a first channel occupancy time (COT) duration associated with a first channel occupancy initiated by the UE, wherein the first COT duration corresponds to a first portion of a UE fixed frame period (FFP); and
initiating, based at least in part on performing a listen-before-talk (LBT) procedure, a second channel occupancy having a second COT duration, wherein the second COT duration is associated with a COT of a base station FFP, wherein the COT of the base station FFP is outside of the COT of a UE FFP.

23. The method of claim 22, further comprising transmitting, to the UE, a COT duration indication that indicates the first COT duration.

24. The method of claim 23, wherein transmitting the COT duration indication comprises transmitting a radio resource control message including a configuration that includes the first COT duration indication.

25. The method of claim 23, wherein transmitting the COT duration indication comprises transmitting a downlink control information (DCI) transmission that includes the COT duration indication.

26. The method of claim 25, wherein the DCI comprises an uplink resource grant.

27. The method of claim 22, further comprising receiving, from the UE, a COT duration indication that indicates the first COT duration.

28. The method of claim 27, wherein receiving the COT duration indication comprises receiving a configured grant (CG)-uplink control information (CG-UCI) transmission that includes the COT duration indication.

29. The method of claim 28, wherein the COT duration indication comprises:
a COT sharing information field of the CG-UCI transmission, or
a dedicated COT duration indication field of the CG-UCI transmission.

30. The method of claim 22, further comprising terminating the second COT duration at a boundary of a base station FFP.
